(19) United States
(12) Patent Application Publication
(10) Pub. No.: US 2026/0010965 A1
(43) Pub. Date: Jan. 8, 2026

(54) SCRIPT CLEARANCE SYSTEMS, AND METHODS OF PROVIDING THEREOF

(71) Applicant: The No Conflict Clearance Company Inc., Toronto (CA)

(72) Inventors: William Cubitt-Smith, Bangor (GB); Mitchel James Fleming, Toronto (CA)

(21) Appl. No.: 18/764,287

(22) Filed: Jul. 4, 2024

(51) Int. Cl. G06Q 50/18; G06Q 40/08

(52) U.S. Cl. CPC G06Q 50/184; G06Q 40/08

(57) ABSTRACT

A system and method for applying one or more artificial intelligence models to analyze a script for legal clearance are disclosed. The method involves automatically identifying one or more script elements within the script; generating one or more script segments from the one or more script elements; for each script segment, operating the one or more artificial intelligence models according to an entity identification prompt to automatically identify one or more entities within the script segment; generating a set of entities from the one or more entities; defining a characteristics prompt for each entity; for each entity, operating the one or more artificial intelligence models according to the associated characteristics prompt to automatically extract the set of entity characteristics; displaying an interactive script; receiving a user feedback; and in response to an approval from a user, executing a set of clearance searches for each entity according to the entity type.

### FIELD

The described embodiments relate to script clearance systems and methods of providing the script clearance systems. In particular, the script clearance systems involve applying one or more artificial intelligence models for analyzing a script for legal clearance.

### BACKGROUND

In the entertainment industry, insurance providers may provide errors and omissions insurance to producers and distributors of media such as movies and TV shows. A requirement to obtain such errors and omissions insurance generally includes obtaining a title clearance search report and a script clearance search report. The title clearance search report indicates whether the title is clear for use. The script clearance search report identifies one or more entities in the script and indicates whether the one or more entities are clear for use.

A script clearance search generally requires a person to manually identify each entity within the script that needs to be cleared through a clearance search. Such entities can include, for example, character names, business names, set locations, personal information, trademarked and copyright materials, media references, and other potentially tortious materials. The person subsequently performs one or more clearance searches for each identified entity. The one or more clearance searches typically vary depending on characteristics of the entity, such as the type of entity. For example, character name entities will generally require different clearance searches to be performed than business name entities. Identifying all entities which require clearance, and then then performing appropriate searches manually is time and labor intensive.

### SUMMARY

The various embodiments described herein generally relate to methods for applying one or more artificial intelligence models to analyze a script for legal clearance, and script clearance systems.

In accordance with an example embodiment, there is provided a method for applying one or more artificial intelligence models to analyze a script for legal clearance. The method includes automatically identifying one or more script elements within the script based on one or more of a script property and a script content; generating one or more script segments from the one or more script elements; for each script segment, operating the one or more artificial intelligence models according to an entity identification prompt to automatically identify one or more entities within the script segment; generating a set of entities from the one or more entities identified from the one or more script segments; defining a characteristics prompt for each entity of the set of entities, the characteristics prompt comprising a set of prompts for extracting from the script a set of entity characteristics related to an entity type and the entity; for each entity of the set of entities, operating the one or more artificial intelligence models according to the associated characteristics prompt to automatically extract the set of entity characteristics from the script; displaying an interactive script embedded with at least a subset of each set of entity characteristics; receiving, via a user interface, a user feedback in respect of one or more of the set of entities and the script; and in response to an approval from a user via the user interface, executing a set of clearance searches for each entity according to the entity type.

In some embodiments, the method includes operating the one or more artificial intelligence models to generate an entity description with the set of entity characteristics extracted for each entity to provide context for the entity in order to facilitate the user feedback.

In some embodiments, the method includes analyzing the set of entities to remove any repeated references.

In some embodiments, analyzing the set of entities to remove any repeated references includes analyzing the script to determine one or more entities identified following the entity identification prompt is the same entity.

In some embodiments, the one or more entities includes one or more different identifiers within the script.

In some embodiments, receiving the user feedback in respect of the one or more of the set of entities and the script content includes receiving a modification of at least one entity of the set of entities based on a review of the interactive script and the method includes analyzing the user feedback to identify one or more issues related to the script analysis; and modifying one or more of the entity identification prompt and the characteristics prompt to address the one or more issues.

In some embodiments, analyzing the user feedback to identify the one or more issues related to the script analysis includes analyzing the user feedback received form a plurality of interactive scripts.

In some embodiments, the entity type is selected from one or more of a character, a business, a set type, a media reference, and a location.

In some embodiments, defining the characteristics prompt for each entity of the set of entities includes analyzing the entity to identify the associated entity type; determining one or more characteristics critical for that entity and the entity type; and defining the set of prompts for collecting the set of entity characteristics related to the one or more characteristics.

In some embodiments, the one or more artificial intelligence models includes one or more generative artificial intelligence models.

In accordance with another example embodiment, there is provided a system for applying one or more artificial intelligence models to analyze a script for legal clearance. The system includes a processor operable to automatically identify one or more script elements within the script based on one or more of a script property and a script content; generate one or more script segments from the one or more script elements; for each script segment, operate the one or more artificial intelligence models according to an entity identification prompt to automatically identify one or more entities within the script segment; generate a set of entities from the one or more entities identified from the one or more script segments; define a characteristics prompt for each entity of the set of entities, the characteristics prompt comprising a set of prompts for extracting from the script a set of entity characteristics related to an entity type and the entity; for each entity of the set of entities, operate the one or more artificial intelligence models according to the associated characteristics prompt to automatically extract the set of entity characteristics from the script; display an interactive script embedded with at least a subset of each set of entity characteristics; receive, via a user interface, a user feedback in respect of one or more of the set of entities and the script; and in response to an approval from a user via the user interface, execute a set of clearance searches for each entity according to the entity type.

In some embodiments, the processor is operable to operate the one or more artificial intelligence models to generate an entity description with the set of entity characteristics extracted for each entity to provide context for the entity in order to facilitate the user feedback.

In some embodiments, the processor is operable to analyze the set of entities to remove any repeated references.

In some embodiments, analyzing the set of entities to remove any repeated references includes analyzing the script to determine one or more entities identified following the entity identification prompt is the same entity.

In some embodiments, the one or more entities includes one or more different identifiers within the script.

In some embodiments, receiving the user feedback in respect of the one or more of the set of entities and the script includes receiving a modification of at least one entity of the set of entities based on a review of the interactive script; and the processor is operable to analyze the user feedback to identify one or more issues related to the script analysis; and modify one or more of the entity identification prompt and the characteristics prompt to address the one or more issues.

In some embodiments, analyzing the user feedback to identify the one or more issues related to the script analysis includes analyzing the user feedback received from a plurality of interactive scripts.

In some embodiments, the entity type is selected from one or more of a character, a business, a set type, a media reference, and a location.

In some embodiments, defining the characteristics prompt for each entity of the set of entities includes analyzing the entity to identify the associated entity type; determining one or more characteristics critical for that entity and the entity type; and defining the set of prompts for collecting the set of entity characteristics related to the one or more characteristics.

In some embodiments, the one or more artificial intelligence models includes one or more generative artificial intelligence models.

### BRIEF DESCRIPTION OF THE DRAWINGS

Several embodiments will now be described in detail with reference to the drawings, in which:

FIG. 1 is a block diagram of components interacting with a script clearance system in accordance with an example embodiment;

FIG. 2 is a flowchart of an example embodiment of a method for applying one or more artificial intelligence models to analyze a script for legal clearance, in accordance with an example embodiment;

FIG. 3 is a diagram illustrating example users interacting with the script clearance system of FIG. 1, in accordance with an example embodiment;

FIG. 4 is an illustration of an example user interface displaying an example script, in accordance with an example embodiment;

FIG. 5 is an illustration of an example user interface displaying an initial information summary and payment interface, in accordance with an example embodiment;

FIG. 6 is an example interactive script, in accordance with an example embodiment;

FIG. 7 is an example section of the interactive script of FIG. 6, in accordance with an example embodiment;

FIG. 8 is an illustration of an example user interface with an example clearance search result list, in accordance with an example embodiment; and

FIG. 9 is an illustration of an example user interface with an example comment to include in a script clearance search report, in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

Legal clearance of a script can include analyzing the script, performing one or more clearance searches, and generating a script clearance search report. This process can be time and labor intensive, as the process is generally performed manually by a human. The human performing the script clearance process can make errors when analyzing the script and/or can fail to identify links and/or associations between particular entities and/or contextual features within the script, which can result in an insufficient script clearance analysis. It is important when performing the script clearance process to correctly identify all entities that are required to be cleared, particularly when the script clearance report is required for errors and omissions insurance. Failing to identify an entity for clearance and/or incorrectly identifying an entity can result in an insufficient or inaccurate script clearance search report.

Currently, the script clearance process generally involves a human who manually reviews a script to identify any entities that need to be searched and cleared. For example, the human identifies each character name, business name, set location, and media reference in the script, as well as various other entity characteristics and features, including but not limited to an entity type. The human must also identify when a single entity is referred to using two or more different identifiers within the script. For example, a single character may be referred to using a full name and a nickname within the script. The human must identify that such references are associated with the same character. The human can make errors during this process, for example, by missing an entity or failing to identify a connection between different references to the same entity.

The human subsequently analyzes the script again to identify further information, such as contextual information, in the script to assist in defining the scope of the clearance searches to be performed and/or defining the relevance of the clearance search results. For example, extracting a character's occupation from the script can define the relevance of the clearance search results for that character's name (e.g., a non-fictional person of the same name with the same occupation as the character may be highly relevant).

The human then performs the required clearance searches for each identified entity to be cleared and generates the script clearance search report based on the clearance search results.

The types of clearance searches to be performed can vary based on the characteristics of the entity being cleared (e.g., the type of entity). For example, clearance searches for a character name may involve a two-part search where the character's name is first run through a proprietary database to estimate the prevalence of that particular character's name in a given geographical region followed by targeted database searches to identify any specific persons sharing the character's name and other attributes. As another example, clearance searches for a fictional business name may involve a similar two-part search where a search of the business name is run through one or more licensed databases whereafter a targeted search of the business in the corresponding geographical location (if known) is undertaken to determine whether any non-fictional businesses exist with the same name in the relevant area. Accordingly, it is important that the identified entities are associated with the correct entity characteristics, such as the correct entity type.

As discussed, the scope of the clearance searches and the relevance of the clearance search results can be limited based on the context of the script. For example, if a particular script takes place in London, UK, a business name clearance search result indicating the existence of a business with the same name in Alabama, US likely is not highly relevant. Accordingly, it is important to be able to identify such contextual features, which might not always be obvious to a human reader, within the script and associate such contextual features with the appropriate entity to be cleared.

The various embodiments described herein generally relate to script clearance systems involving one or more artificial intelligence models for analyzing a script for legal clearance (and methods for applying one or more artificial intelligence models to analyze a script for legal clearance). The methods involve automatically identifying one or more script segments within the script based on one or more of a script property and a script content. For each script segment, the one or more artificial intelligence models can be operated according to an entity identification prompt to automatically identify one or more entities within the script segment. A set of entities can be generated from the one or more entities identified from the one or more script segments. A characteristics prompt can be defined for each entity of the set of entities. The characteristics prompt can include a set of prompts for extracting from the script a set of entity characteristics related to an entity type and the entity. For each entity of the set of entities, the one or more artificial intelligence models can be operated according to the associated characteristics prompt to automatically extract the set of entity characteristics from the script. An interactive script embedded with at least a subset of each set of entity characteristics can be displayed. A user can provide feedback via a user interface in respect of one or more of the set of entities and the script. In response to an approval from the user via the user interface, a set of clearance searches can be executed for each entity according to the entity type.

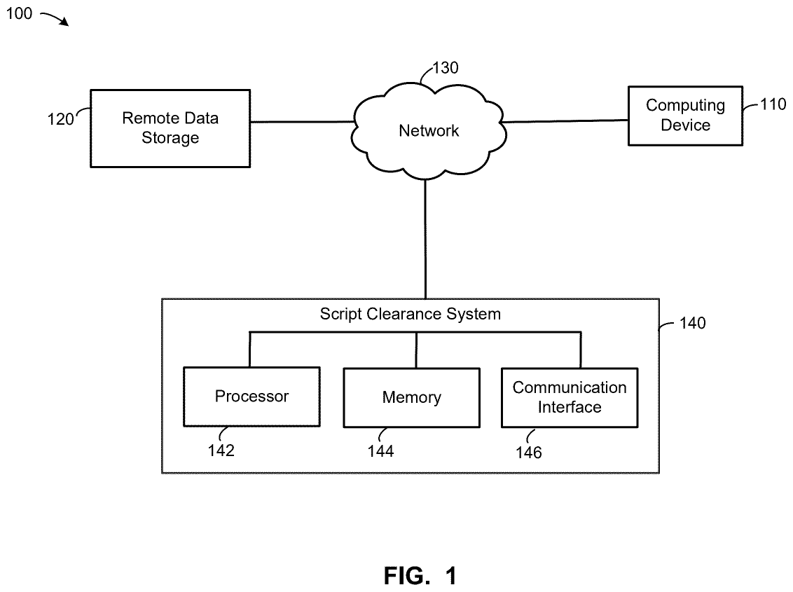

Reference is first made to FIG. 1, which illustrates a block diagram 100 of components interacting with a script clearance system 140. As shown in FIG. 1, the script clearance system 140 can be in communication with a computing device 110 and a remote data storage 120 via a network 130.

The script clearance system 140 includes a processor 142, a memory 144 and a communication interface 146. The processor 142, the memory 144 and the communication interface 146 may be implemented in software or hardware, or a combination of software and hardware. The processor 142, the memory 144 and the communication interface 146 can be combined into fewer number of components or may be separated into further components. The script clearance system 140 may, in some embodiments, be split into multiple computing systems that may be distributed over a wide geographic area and connected via the network 130.

The processor 142 is configured to control the operation of the script clearance system 140. The processor 142 may be any suitable processors, controllers or digital signal processors that can provide sufficient processing power depending on the configuration, purposes and requirements of the script clearance system 140. In some embodiments, the processor 142 can include more than one processor with each processor being configured to perform different dedicated tasks. For example, the processor 142 can operate to automatically identify one or more script segments within a script. The processor 142 can further operate the one or more artificial intelligence models according to a prompt to ultimately generate and/or extract from the script a set of entities and/or a set of entity characteristics. The processor 142 can further, for example, receive user feedback via a user interface and execute a set of clearance searches based, directly or indirectly, on the set of entities and/or the set of entity characteristics.

The memory 144 can include RAM, ROM, one or more hard drives, one or more flash drives or some other suitable data storage elements such as disk drives, etc. For example, the memory 144 can store one or more scripts that are uploaded to the script clearance system 140. In some embodiments, the one or more scripts are stored on the memory 144 temporarily (e.g., the script may be deleted from memory 144 following execution of the script clearance process). The memory 144 can store initial information extracted from the script, such as script title, author, time period, and setting of the script. The memory 144 can also store one or more entities identified by the one or more artificial intelligence models and/or the set of entities generated based on one or more identified entities. The memory 144 can also store the set of entity characteristics extracted from the script. The memory 144 can further store the user feedback received via the user interface. The user feedback can vary in substance, such as, for example and not of limitation, approval of one or more identified entity and/or set of entity characteristics, correction and/or modification to one or more identified entity and/or set of entity characteristics, addition of one or more entity that was not identified by the one or more artificial intelligence models and/or an entity characteristic, and/or deletion of one or more entity that was incorrectly identified as being an entity that required clearance and/or an entity characteristic that was incorrectly identified as being a relevant entity characteristic. In some embodiments, the memory 144 can store the one or more artificial intelligence models and/or the one or more clearance search databases.

The communication interface 146 may be any interface that enables the script clearance system 140 to communicate with other devices and systems. The communication interface 146 may also include at least one of an Internet, Local Area Network (LAN), Ethernet, Firewire, modem or digital subscriber line connection. Various combinations of these elements may be incorporated within the communication interface 146. For example, the communication interface 146 may receive input from various input devices, such as a mouse, a keyboard, a touch screen, a thumbwheel, a track-pad, a track-ball, a card-reader, voice recognition software and the like depending on the requirements and implementation of the script clearance system 140.

The remote data storage 120 can include one or more processors with computing processing abilities and memory such as a database(s) or file system(s). Although only one remote data storage 120 is shown for ease of exposition, there may be multiple remote data storage 120 distributed over a wide geographic area and connected via network 130. The remote data storage 120 can be used to store back-up data in some embodiments, and/or data less frequently accessed by the script clearance system 140. For example, the remote data storage 120 can store data related to completed script clearances.

The computing device 110 may be any networked device operable to connect to the network 130. A networked device is a device capable of communicating with other devices through a network such as the network 130. A networked device may couple to the network 130 through a wired or wireless connection. These computing devices 110 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

Although only one computing device 110 is shown in FIG. 1, it will be understood that more than one computing device 110 can communicate with the script clearance system 140 at any one time. The computing device 110 can be used by a user of the script clearance system 140. In some embodiments, a connection request initiated from the computing device 110 may be initiated from a web browser and directed at the browser-based communications application on the script clearance system 140. In some embodiments, computing device 110 includes separate computing devices for different users interacting with the script clearance system 140. For example, the different users can include a customer who uploads a script for clearance and receives the generated script clearance search report; a script clearance searcher who can provide feedback on the analyzed script and/or can provide one or more comments for the script clearance search report; and/or a third-party, such as an insurance company, that can receive the generated clearance search report. The computing device 110 can include a user interface that allows a user to interact with computing device.

The network 130 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between the script clearance system 140, the computing device 110, the one or more artificial intelligence models, the one or more clearance search databases, and the remote data storage 120.

One or more artificial intelligence models can be accessed by the script clearance system 140 via the network 130. For example, in some embodiments, the one or more artificial intelligence models can be stored on remote data storage 120. In some embodiments, the one or more artificial intelligence models can be local to the script clearance system 140 (e.g., stored on memory 144). In some embodiments, the one or more artificial intelligence models includes one or more generative artificial intelligence models such as a large language model (LLM). In some embodiments, the one or more artificial intelligence models include one or more externally provided and/or externally available models. For example, in some embodiments, the one or more artificial intelligence models include one or more third-party models. In some embodiments, the one or more artificial intelligence models are trained to receive a plain language prompt and output a plain language response. In some embodiments, other types of artificial intelligence models are used.

One or more clearance search databases can be accessed by the script clearance system 140 via the network 130. For example, in some embodiments, the one or more clearance search databases can be stored on remote data storage 120. In some embodiments, the one or more clearance search databases can be local to the script clearance system 140 (e.g., stored on memory 144). The one or more clearance search databases can include data related to one or more entities that may need to be cleared in any given script. For example, the one or more clearance search databases can include data related to non-fictional persons' names, occupations, and/or locations. As another example, the one or more clearance search databases can include data related to non-fictional business names, locations, and/or area of goods or services. As a further example, the one or more clearance search databases can include data related to works of media, such as movies, TV shows, podcasts, and/or books. The one or more clearance search databases can include, for example, Google®, IMDB®, OpenCorporates, US Trademark Registry, and/or internal, proprietary databases (e.g., a Name Census database). In some embodiments, the one or more clearance search databases are accessed by the script clearance system 140 via one or more application programming interfaces (APIs).

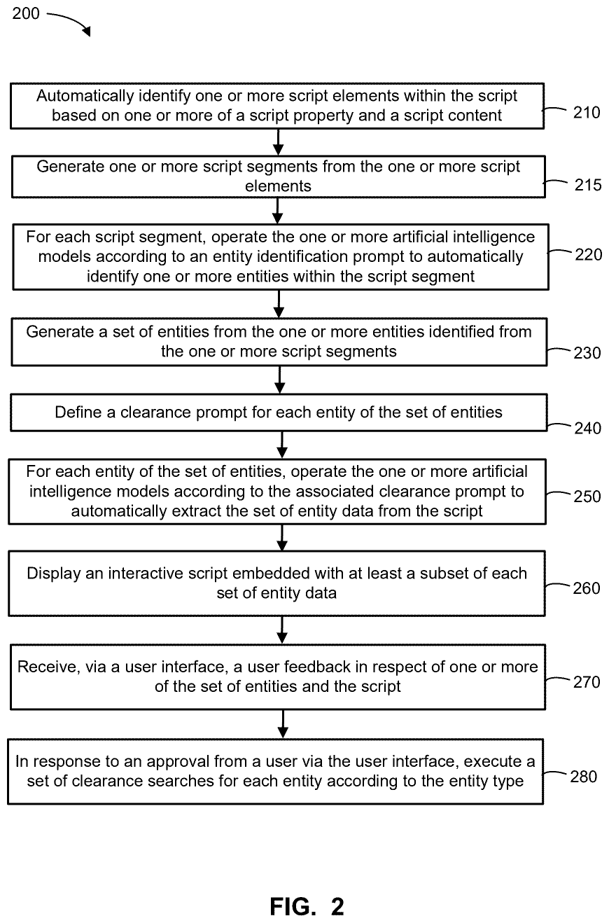

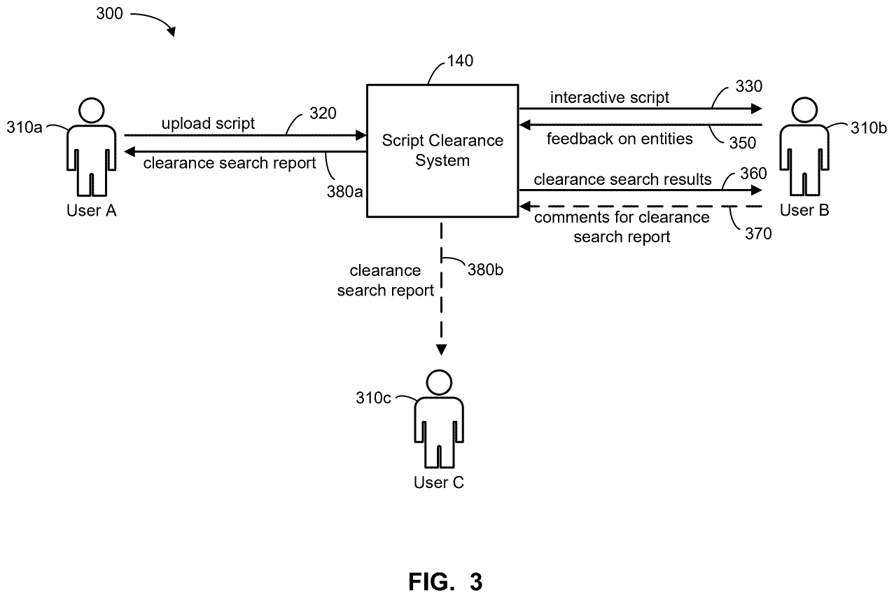

Referring now to FIG. 2, shown therein is a flowchart of an example method 200 for applying one or more artificial intelligence models to analyze a script for legal clearance. To illustrate the method 200, reference will be made to FIGS. 3 to 9.

At 210, the processor 142 automatically identifies one or more script elements within the script based on one or more of a script property and a script content.

Referring to FIG. 3, shown therein is a block diagram of users interacting with the script clearance system 140. As shown, user A 310a uploads a script 320 to the script clearance system 140. In some embodiments, user A 310a uploads the script 320 to the script clearance system 140 via a user interface. In some embodiments, the user interface can include a user interface of computing device 110. In some embodiments, the script is uploaded 320 as a portable document format (PDF) file. However, it should be understood that any other suitable file format (e.g., word processing document) is contemplated.

In some embodiments, user A 310a can include a customer who requires a clearance search report. For example, user A 310a can include a media producer, a media distributer, a script writer, or a director.

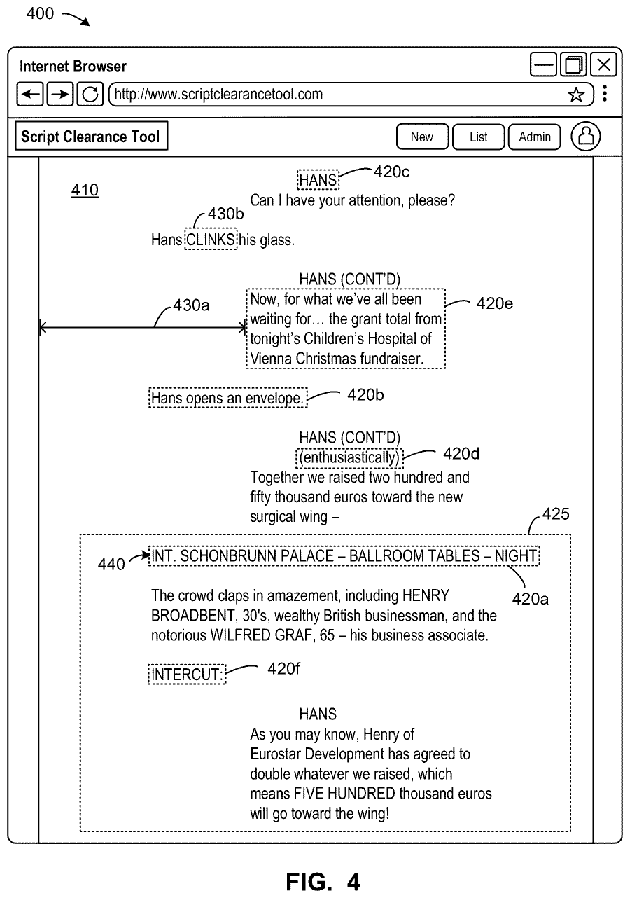

Referring to FIG. 4, shown therein is an example user interface 400 displaying an example script 410. Although the example user interface 400 shown in FIG. 4 is displayed as a webpage in web browser, it should be understood that the script clearance system 140 can be implemented using other suitable implementations. For example, the script clearance system 140 can be implemented using a desktop application or a mobile application.

The script 410 can include, for example, a screenplay (e.g., a movie script) or a teleplay (e.g., a television script). The script 410 can include a script intended for various purposes such as, for example, an adapted script, a spec script, a standalone script, a pitch script, or a shooting script.

As shown in FIG. 4, the script 410 can include one or more script elements 420. The script elements 420 can include, for example, a scene heading 420a, an action 420b, a character name 420c, a parenthetical 420d, dialogue 420e, and a transition 420f.

The scene heading 420a, which may be referred to as the slugline, provides information about the scene setting. For example, the scene heading 420a can indicate whether the scene is interior or exterior, the location of the scene, and whether the scene takes place during the day or the night.

The action 420b provides information about any action that can be heard or seen during the scripted scene. The action 420b can further provide information about the appearance of the scene and/or the characters' positioning in the scene. For example, the action 420b can provide information about what a character is doing during the scene, where a character is positioned during the scene, any notable objects that are visible during the scene, and/or any sound effects that are heard during the scene.

The character name 420c provides information about a character who is speaking in the scene. The character name 420c is typically immediately followed by that character's dialogue block 420e. In some embodiments, the character name 420c is immediately followed by a parenthetical 420d and then the dialogue block 420e.

The parenthetical 420d provides information about how the subsequent dialogue 420e is intended to be delivered. For example, the parenthetical 420d can indicate that the performer should “breath heavily” or that the dialogue should be delivered sarcastically.

The dialogue 420e provides the words spoken by a character. In some embodiments, the dialogue 420e can include dual dialogue, which represents two characters speaking at the same time. Dual dialogue is represented by two dialogue blocks side by side, each preceded by the respective character name 420c.

The transition 420f provides information about how the current scene should change to the next scene. For example, the transition 420f can indicate that the scene should “fade out” or “cut to”.

As shown in FIG. 4, the script 410 can include one or more script properties 430. The script property 430 can include, for example, a formatting feature of the script. In some embodiments, the formatting feature includes the indentation 430a of a script element 420. In some embodiments, the formatting feature includes a font property 430b of a script element 420, such as bold text, underlined text, italicized text, or capitalized text.

As shown in FIG. 4, the script 410 can include script content 440. The script content 440 can include, for example, the text content of the script 410. For example, the scene heading 420a typically begins with the script content “EXT.” or the script content “INT.” 440. As another example, the script content 440 can include an adverb adjacent a character name 420c to assist in identifying dialogue 420e.

The processor 142 uses one or more of a script property 430 and a script content 440 to automatically identify one or more script elements 420. In some embodiments, this involves applying a modified optical character recognition (OCR) technique to the script 410. The modified OCR technique can involve incorporating knowledge of a script 410 based on the script property 430 and/or the script content 440. For example, applying a standard OCR technique to a script, such as script 410, can identify text on each page, including the location on the page at which that text is found. The processor 142 combines this OCR output with one or more of the script property 430 and the script content 440 to identify different script elements 420, including a type 420a-f of the script element 420. For example, the processor 142 can use the script property 430 (e.g., indentation 430a of identified text) to determine that identified script element 420e is a dialogue block. As another example, the processor 142 can use the script content 440 (e.g., text “INT.”) to determine that identified script element 420a is a scene heading.

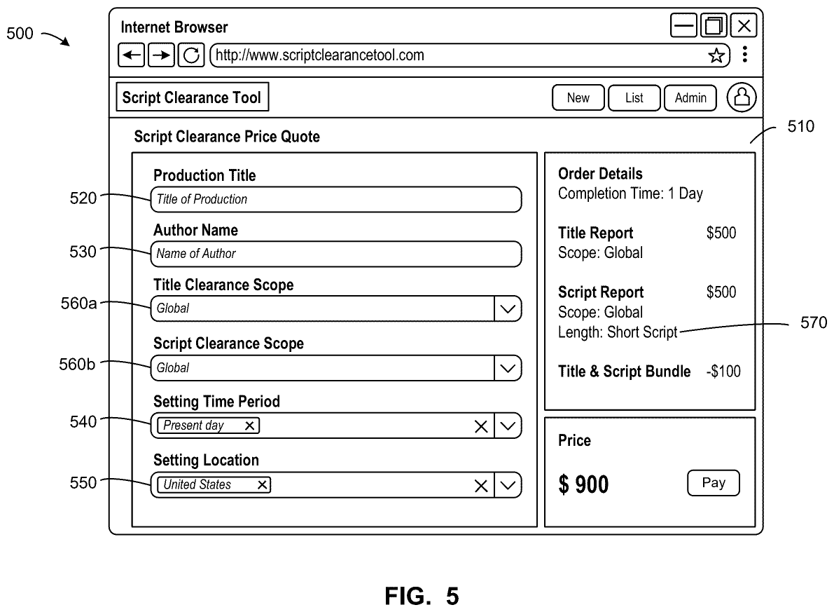

Referring now to FIG. 5, shown therein is an example user interface 500 displaying an initial information summary and payment interface 510. Although the example user interface 500 shown in FIG. 5 is displayed as a webpage in a web browser, it should be understood that the script clearance system 140 can be implemented using other suitable implementations. For example, the script clearance system 140 can be implemented using a desktop application or a mobile application.

In some embodiments, the processor 142 can perform an initial analysis in which the processor 142 operates to identify initial script information such as title 520, author 530, time period 540, and setting of the script 550, and displays this identified initial script information on the initial information summary and payment interface 510. In some embodiments, the processor 142 performs a word count on the uploaded script to determine an estimated script length 570 (e.g., short script or feature length script). In some embodiments, the processor 142 operates the one or more artificial intelligence models according to an initial script information prompt to automatically identify the initial script information. The initial script information prompt can include, for example, an extract of the script and a request to identify the title 520, author 530, time period 540, and/or setting of the script 550. In some embodiments, the extract of the script can include the first 1-5 pages of the script. In some embodiments, the initial script information prompt can provide a set of options for the time period 540 (e.g., a set of eras) and a set of options for the setting of the script 550 (e.g. a set of countries) to select from. In some embodiments, the prompt allows open-ended outputs for the title 520 and author 530.

Following the initial analysis, user A 310a can confirm and/or modify the identified initial script information. For example, in some embodiments, user A 310a can modify one or more portions of the identified initial script information if the identified initial script information is incorrect or incomplete.

In some embodiments, user A 310a inputs additional information such as the scope of the searches 560. In some embodiments, the scope of the title clearance search 560a can be different from or the same as the scope of the script clearance search 560b. The scope of the searches 560 can be jurisdictional. In some embodiments, the scope of the searches 560 can be global, for example. In other embodiments, the scope of the searches 560 can be limited to North America, for example. These exemplary scopes are provided as examples only, and it should be understood that any other suitable scope is possible. In some embodiments in which the clearance search reports are being generated for the purpose of obtaining errors and omissions insurance, the insurance company providing the insurance coverage can determine the scope of the searches 560.

In some embodiments, one or more portions of the identified initial script information can be used by the script clearance system 140 to narrow the scope of and/or provide context for one or more clearance searches to be conducted. For example, if the setting of the script 550 is determined to be London, UK, the script clearance system 140 does not need to perform clearance searches related to, for example, Alabama, US, as this would fall outside the relevant scope for the clearance search.

Referring to FIG. 2, at 215, the processor 142 generates one or more script segments from the one or more script elements 420.

Referring to FIG. 4, a script segment 425 can include one or more script elements 420. For example, in some embodiments, script segment 425 includes all script elements 420 in a particular scene of the script 410. In some embodiments, script segment 425 includes all script elements 420 in a range of pages of the script 410 (e.g., pages 3-5 of the script 410). In some embodiments, script segment 425 includes the entire script 410.

Referring to FIG. 2, at 220, for each script segment 425, the processor 142 operates the one or more artificial intelligence models according to an entity identification prompt to automatically identify one or more entities within the script segment 425.

The entity identification prompt can include a prompt to operate the one or more artificial intelligence models to identify one or more entities within the script segment 425. Accordingly, the entity identification prompt can include input data such as the script segment being analyzed, and one or more of the script property 430 and the script content 440. In some embodiments, the entity identification prompt can include a list of possible entity types (e.g., character name, business name, set location, or media reference) to identify.

In some embodiments, the entity type is selected from one or more of a character, a business, a set type, a media reference, and a location. However, it should be understood that other types of entities can be identified within the script.

In some embodiments, the entity identification prompt comprises plain language text. In such embodiments, the plain language text is defined such that one or more of the script property 430 and the script content 440 is accounted for in the entity identification prompt. That is, the one or more artificial intelligence models can “see” the structure of the script segment 425 being analyzed based on one or more of the script property 430 and the script content 440. For example, in some embodiments, the entity identification prompt includes specific spacing (e.g., indentations) so that the text of the entity identification prompt appears like a typical script. In other embodiments, the entity identification prompt includes a marked-up representation of the script using, for example, yaml, xml, or json formatting.

In some embodiments, the entity identification prompt is specific to one or more characteristics of an entity, such as an entity type (e.g., character name). For example, the entity identification prompt can be defined to identify only character names within the script segment 425 being analyzed. In some embodiments, the entity identification prompt is defined to identify entities of any entity type (e.g., character names, business names, media references etc.) within the script segment 425 being analyzed.

In some embodiments, the entity identification prompt includes a request to identify the entity type of each identified entity. The processor 142 can associate the identified entity type with the corresponding identified entity. For example, the processor 142 can store each identified entity with the associated entity type in the memory 144.

In some embodiments, the entity identification prompt includes a format in which the output of the one or more artificial intelligence models should be provided.

Referring to FIG. 2, at 230, the processor 142 generates a set of entities from the one or more entities identified from the one or more script segments 425.

In some embodiments, the set of entities includes a complete set of all entities identified in the entire script 410. That is, in some embodiments, the set of entities includes all entities identified from the one or more script segments 425, such that the set of entities includes each entity identified in each script segment 425.

In some embodiments, the set of entities is specific to a particular entity characteristic, such as an entity type. For example, in some embodiments, the set of entities includes a set of entities for identified character names, a set of entities for identified business names, a set of entities for identified set locations, and/or a set of entities for identified media references.

For example, a character name set of entities can include each character name identified in each script segment 425, such that the character name set of entities includes a complete list of every identified character name in the entire script 410.

In some embodiments, method 200 further comprises analyzing the set of entities to remove any repeated references. In some embodiments, analyzing the set of entities to remove any repeated references comprises analyzing the script 410 to determine that one or more entities identified following the entity identification prompt is the same entity. In some embodiments, the one or more entities that is identified as being the same entity includes one or more different identifiers within the script 410. For example, in some embodiments, the processor 142 operates to identify and merge duplicate entities. For example, if a single character, “John”, is referred to using a plurality of identifiers within the script 410 such as “John Doe”, “John”, and “Johnny”, the set of entities may include three separate entities due to three different identifiers being used to refer to the same character. In such embodiments, the processor 142 operates to identify that these identifiers are linked, and accordingly, are duplicate entities within the set of entities. Once duplicate entities are identified, the processor 142 operates to merge the entities such that the identifiers are represented as a single entity.

In some embodiments, the entity identification prompt is defined to identify all names used to refer to each identified character in the analyzed script segment 425. For example, in some embodiments, the one or more artificial intelligence models is operated according to the entity identification prompt to automatically identify that there is a character, John, known as John Doe, John, and Johnny. In some embodiments, the processor 142 operates to identify and merge duplicate entities based on a common entity identified in more than one script segment 425. For example, the processor 142 can operate to determine that a character entity known as John Doe and John was identified in a first script segment, and that a character entity known as John and Johnny was identified in a second script segment, and that these two character entities relate to the same character entity, due to the common reference to John, and should accordingly be merged.

In some embodiments, the processor 142 can store the set of entities in the memory 144.

Referring to FIG. 2, at 240, the processor 142 defines a characteristics prompt for each entity of the set of entities.

The characteristics prompt comprises a set of prompts for extracting from the script 410 a set of entity characteristics related to an entity type and the entity. For example, the set of entity characteristics provides further information about the entity.

The types of further information to be identified may vary depending on the entity type and the individual entity for which the characteristics prompt is defined. That is, different entity types can have different types of entity characteristics extracted from the script 410.

In some embodiments, defining the characteristics prompt for each entity of the set of entities comprises analyzing the entity to identify the associated entity type; determining one or more characteristics critical for that entity and the entity type; and defining the set of prompts for collecting the set of entity characteristics related to the one or more characteristics. In some embodiments, analyzing the entity to identify the associated entity type involves retrieving from memory 144 the entity type that is associated with the entity.

As an example, for a character name entity, the processor 142 can define a characteristics prompt to extract from the script 410 a set of entity characteristics related to the character name entity type. The set of entity characteristics for a character name entity type can include, for example, the character's age, occupation, geographical location, any unfavorable characteristics and/or defamatory plot points, and major plot points. In some embodiments, the set of entity characteristics can include whether or not the character is the primary character. For a character who is identified as being the primary character, that character's determined geographical location can be used as the location in which the script is set.

For a business name entity, the processor 142 can define a characteristics prompt to extract from the script 410 a set of entity characteristics related to the business name entity type. The set of entity characteristics for a business name entity type can include, for example, the business' name, geographical location, industry, unfavorable characteristics, and major plot points.

For a set location entity, the processor 142 can define a characteristics prompt to extract from the script 410 a set of entity characteristics related to the set location entity type. The set of entity characteristics for a set location entity type can include, for example, the geographical location, whether the location is interior or exterior, whether the set location is associated with a real (i.e., non-fictional) location, any private information related to the set location, and the time of day.

For a media reference entity, the processor 142 can define a characteristics prompt to extract from the script 410 a set of entity characteristics related to the media reference entity type. The set of entity characteristics for a media reference entity type can include, for example, the media type (e.g., book, TV show, movie, podcast etc.), the reference type (e.g., quoted, referenced by name, played etc.), reference sentiment (e.g., positive, negative, neutral etc.), the nature of the media reference, and whether the media referenced is real (i.e., non-fictional) or whether it was created for the purposes of the script.

Referring to FIG. 2, at 250, for each entity of the set of entities, the processor 142 operates the one or more artificial intelligence models according to the associated characteristics prompt to automatically extract the set of entity characteristics from the script 410.

Once the processor 142 operates the one or more artificial intelligence models according to the characteristics prompt for each entity of the set of entities, each entity of the set of entities will have an associated set of entity characteristics.

For example, once the processor 142 operates the one or more artificial intelligence models according to the characteristics prompt for each character name entity of the set of entities, a complete set of characters identified in the script 410 and a set of entity characteristics for each identified character will have been generated. The set of entity characteristics for each entity can be used by the script clearance system 140 in other steps of method 200.

In some embodiments, method 200 further comprises operating the one or more artificial intelligence models to generate an entity description with the set of entity characteristics extracted for each entity to provide context for the entity in order to facilitate the user feedback. The entity description can vary based on one or more characteristics of the entity, such as the entity type. For example, for a character name entity type, the entity description can include a summary of the character, including the identifiers used to reference that character within the script 410, and/or the character's age, occupation, location, unfavorable characteristics, and/or main plot points.

Referring to FIG. 2, at 260, the processor 142 displays an interactive script embedded with at least a subset of each set of entity characteristics.

Referring to FIG. 3, user B 310b can view the interactive script displayed by the processor 142. User B 310b can include, for example, a person who has a role in performing the clearance searches. For example, user B 310b can include an employee of a clearance search company.

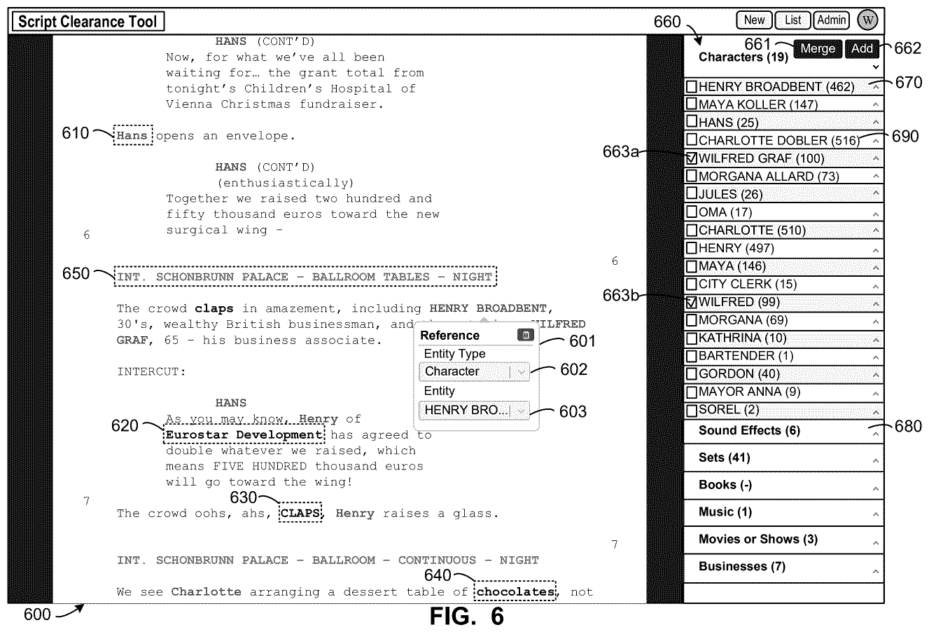

Referring now to FIG. 6, shown therein is an example interactive script 600. As shown, the interactive script 600 can have an appearance similar to a standard script such as script 410. That is, the interactive script 600 can be formatted similar to a standard script. However, the interactive script 600 further includes one or more interactive elements. For example, in some embodiments, the one or more interactive elements can include identified entities and/or script segments. For example, in some embodiments, the one or more interactive elements can include character names 610, business names 620, sound effects 630, sets 640, and scene headings 650. In some embodiments, sets 640 can include notable objects displayed during a scene.

In some embodiments, the one or more interactive elements can be displayed according to a particular color scheme. For example, as shown in FIG. 6, character name entities 610 can be displayed in one color, such as blue, scene heading entities 650 can be displayed in another color, such as green, and the remaining text can be displayed in black. In some embodiments, other interactive element and color scheme combinations are possible.

In some embodiments, the one or more interactive elements can be displayed according to a particular font property scheme. For example, as shown in FIG. 6, business name entities 620 and set entities 640 can be displayed in bold font, and sound effect entities 630 can be displayed in bold and capitalized font. In some embodiments, other interactive element and font property scheme combinations are possible.

In some embodiments, the one or more interactive elements can be displayed according to both a particular color scheme and a particular font property scheme, as shown in the example interactive script 600 of FIG. 6.

As shown in FIG. 6, the interactive script 600 can include an entity section 660 that displays one or more of the identified entities. In some embodiments, the identified entities are organized and displayed based on a particular entity characteristic, such as by entity type. In such embodiments, the list of each entity type can be expanded to display at least a subset of the individual entities 670 of that entity type or collapsed to display only the entity type heading 680. For example, in the example interactive script 600 shown in FIG. 6, the list of character name entities is expanded while the remaining lists of other entity types are collapsed. In some embodiments, each individual entity 670 can include a number 690, which indicates the total number of occurrences of that individual entity 670 within the script.

The interactive script 600 is embedded with at least a subset of each set of entity characteristics. In some embodiments, the subset of each set of entity characteristics is embedded in the entity section 660 of the interactive script 600.

In some embodiments, each individual entity 670 can be expanded or collapsed. In some embodiments, when an individual entity 670 listed in the entity section 660 is expanded, the entity section 660 can display the subset of the corresponding set of entity characteristics.

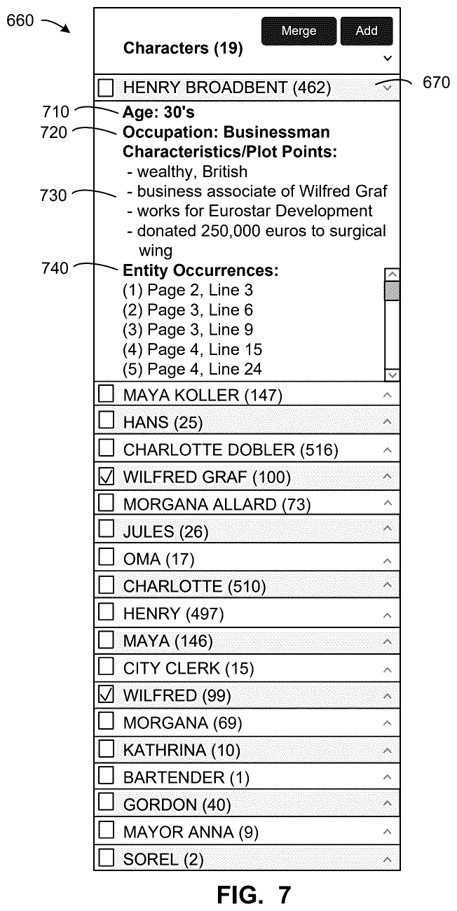

Referring to FIG. 7, shown therein is the entity section 660 of the interactive script 600 of FIG. 6. As shown in FIG. 7, the character name entity “HENRY BROADBENT” 670 is expanded. The expanded view displays at least a subset of the set of entity characteristics associated with the “HENRY BROADBENT” character name entity 670. For example, as shown, the subset of the set of entity characteristics includes Henry Broadbent's age 710, occupation 720, plot points 730, and occurrences within the script 740.

When the individual entity listing 670 is expanded, the entity section 660 can show, for example, one or more occurrences of that entity 670 within the script. For example, user B 310b (or any other user viewing the interactive script 600) can select a particular occurrence of that entity 670, and the interactive script 600 will display that location within the script.

Referring to FIG. 2, at 270, the processor 142 receives, via a user interface, a user feedback in respect of one or more of the set of entities and the script.

Referring to FIG. 3, user B 310b can provide the user feedback 350 based on the interactive script 600. In some embodiments, the user interface includes the interactive script 600.

In some embodiments, the user feedback includes confirmation that all entities in the script are identified and that each identified entity is correctly identified. In some embodiments, a correctly identified entity is an entity that has been associated with the correct entity type. In some embodiments, a correctly identified entity is an entity that is associated with a correct and complete corresponding set of entity characteristics.

In some embodiments, receiving the user feedback in respect of the one or more set of entities and the script includes receiving a modification of at least one entity of the set of entities based on a review of the interactive script 600. In some embodiments, method 200 includes analyzing the user feedback to identify one or more issues related to the script analysis and modifying one or more of the entity identification prompt and the characteristics prompt to address the one or more issues. In some embodiments, analyzing the user feedback to identify the one or more issues related to the script analysis includes analyzing the user feedback received from a plurality of interactive scripts.

For example, in some embodiments, the user feedback can include a correction to one or more of the set of entities, an associated entity type, and the set of entity characteristics. For example, the user feedback can include a modification to an entity type associated with an identified entity. In some embodiments, the user feedback can include an identification of an entity that was not identified by the one or more artificial intelligence models. In some embodiments, the user feedback can include a modification to the set of entity characteristics (e.g., correcting an identified character's identified occupation). In some embodiments, the user feedback can include removing an incorrectly identified entity from the set of entities (e.g., the one or more artificial intelligence models identified a segment of text as being an entity that is not actually an entity).

Referring to FIG. 6, the interactive script 600 can include a feedback section for receiving the user feedback. In some embodiments, the feedback section includes a pop-up window 601. In some embodiments, the pop-up window 601 can appear when user B 310b interacts with an interactive element, such as clicking on the interactive element or hovering a mouse cursor over the interactive element, for example. The pop-up window 601 can display, for example, the selected entity 603 and the entity type 602 of the selected entity 603. The displayed entity type 602 can include a mechanism allowing user B 310b (or another user viewing the interactive script 600) to modify the entity type 602 associated with the selected entity 603. For example, if the one or more artificial intelligence models incorrectly identified a character name entity as being a business name entity, user B 310b could use the pop-up window 601 to correct the entity type 602 to character name. In some embodiments, the pop-up window 601 can include other information, such as at least a subset of the entity characteristics associated with the selected entity 603. In some embodiments, the mechanism for making a modification includes a drop-down menu, as shown in FIG. 6. However, other user interface elements are possible for allowing a modification.

In some embodiments, the feedback section can include merge button 661 and/or add button 662. In some embodiments, user B 310b can select two or more entities listed in entity section 660 to be merged. For example, as shown in FIG. 6, boxes 663a and 663b, corresponding to entities “WILFRED GRAF and “WILFRED”, respectively, are both checked. The user 310b can select the merge button 661 to merge these two entities, as they each correspond to the same entity. In some embodiments, user B 310b can use the add button 662 to add an entity that was not identified by the one or more artificial intelligence models.

The user feedback can be stored in the memory 144. That is, the memory 144 can store a record of the user feedback identifying entities that were correctly identified and entities that were incorrectly identified (including the correction) or not identified at all. This record can be used to modify one or more of the entity identification prompt and the characteristics prompt, as described herein. For example, modifying one or more of the prompts can include adding one or more sentences to the prompt, removing one or more sentences from the prompt, or otherwise modifying the language of the prompt.

In some embodiments, the one or more artificial intelligence models can be operated according to the modified prompt to evaluate whether the modified prompt provides an improved output (e.g., whether the output based on the modified prompt is consistent with the user feedback). For example, if the user feedback includes an identification of an entity in a given script segment that was not identified by the initial prompt, the processor 142 can determine whether the modified prompt correctly identifies that entity when the one or more artificial intelligence models is operated according to the modified prompt.

Referring to FIG. 2, at 280, in response to an approval from a user via the user interface, the processor 142 executes a set of clearance searches for each entity according to the entity type.

In some embodiments, the approval from the user via the user interface includes approval by user B 310b of each identified entity. That is, the user can confirm that each identified entity is correctly identified.

The set of clearance searches can vary based on characteristics of the entity, such as the entity type. For example, for character name entity types, the set of clearance searches can include searches on Google®, online celebrity catalogues, proprietary name databases, and/or historical clearance data.

For business name entity types, the set of clearance searches can include searches on OpenCorporates, federal, provincial, and state business registries, other third-party corporate aggregators, and/or historical clearance data.

For set location entity types, the set of clearance searches can include searches on Google®, federal, provincial, and state business registries, other-third party corporate aggregators, and/or historical clearance data.

For media reference entity types, the set of clearance searches can include searches on IMDB®, ISBN, Google®, Listen Notes, government trademark databases, other third-party aggregators, and/or historical clearance data.

Other possible clearance searches can include searches on trademark aggregators, WorldCat, IGDB, domain name aggregators, other third-party data aggregators, and/or proprietary databases.

In some embodiments, the set of entity characteristics is used to determine the set of clearance searches to be executed for a particular entity. For example, for a media reference entity where the media reference is “Grinch”, the set of entity characteristics can provide context on whether the media reference to “Grinch” includes the movie “The Grinch” playing on a television screen during the scene, or includes dialogue of one character calling another character a “Grinch”, or includes dialogue of a character referring to the movie title “The Grinch” during a scene. That is, the context in which a media reference occurs can influence the set of clearance searches to be executed in relation to that media reference.

In some embodiments, the script clearance system 140 implements one or more application interface programs (APIs) that connect the script clearance system 140 to one or more clearance search databases for performing the set of clearance searches.

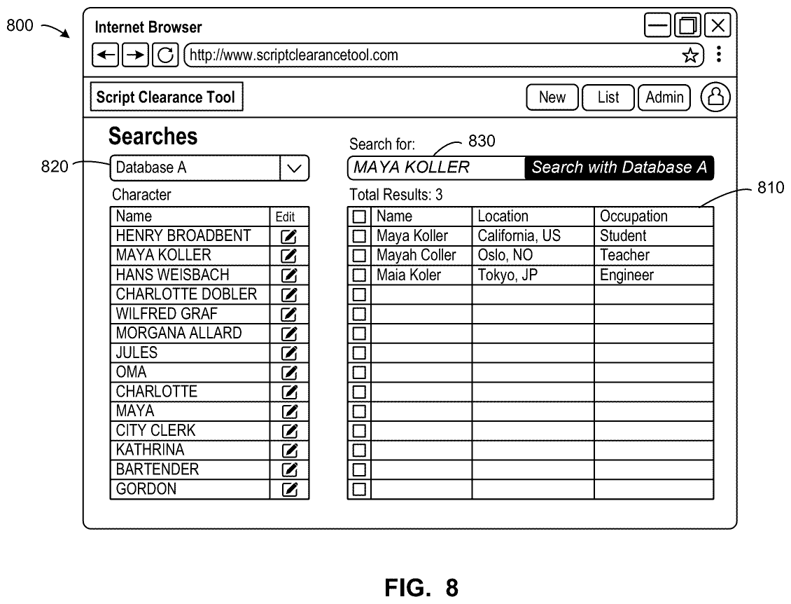

Referring to FIG. 8, shown therein is a user interface 800 with an example result list 810 from a clearance search. As shown, a clearance search was executed on Database A 820 for the character name entity “MAYA KOLLER” 830. The clearance search resulted in three results 810. Of the three results 810, one is an exact name match while the other two results are partial name matches. As shown, the clearance search results 810 can also indicate the location and occupation of the identified individual. Although the clearance search results 810 include information such as name, location, and occupation, it should be understood that additional information or less information can be included.

Referring to FIG. 3, user B 310b can be provided with the clearance search results 360 via, for example, the user interface 800 shown in FIG. 8.

In some embodiments, user B 310b can provide one or more comments 370 to include in a clearance search report based on the clearance search results. In some embodiments, user B 310b can select one or more prewritten comments to include in the clearance search report from a predetermined list of comments. In some embodiments, user B can provide one or more manual comments based on the clearance search results. In some embodiments, the script clearance system 140 automatically generates the clearance search report based on the clearance search results without receiving comments to include from user B. In such embodiments, the processor 142 can operate the one or more artificial intelligence models to generate the clearance search report based on the clearance search results. In some embodiments, the clearance search report is generated using a combination of comments from user B 310b and the one or more artificial intelligence models.

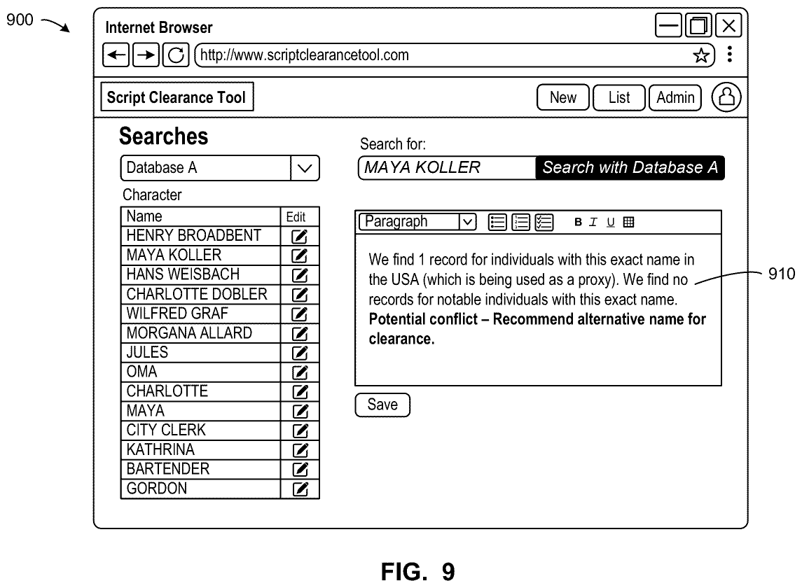

Referring to FIG. 9, shown therein is a user interface 900 with an example comment 910 to include in a script clearance search report. As shown, the comment 910 can provide an indication on whether or not the entity is clear to use based on the search results 810. In some embodiments, the comment 910 can include a recommendation on how to proceed based on the search results 810. For example, the comment 910 can indicate that there is a potential conflict with the searched entity and an alternative is recommended.

Referring to FIG. 3, user A 310a can receive the clearance search report 380a. In some embodiments, user C 310c can receive the clearance search report 380b. In some embodiments, user C 310c can include a third party. For example, user C 310c can include an insurance company that is considering providing errors and omissions insurance to user A 310a.

In some embodiments, interactive script 600 can display at least a portion of the clearance search results, such as, for example, whether or not a particular entity “cleared” the clearance search. For example, in some embodiments, entity section 660 can indicate whether each listed entity is clear for use or not based on the clearance search results. In some embodiments, user A 310a is provided access to the interactive script 600. In such embodiments, user A 310a can select an entity from entity section 660 that has not passed the clearance search and order additional clearance searches with alternative entities (e.g., alternative character names for a character name that did not clear the clearance search).

In some embodiments, the script clearance system 140 is implemented within a script writing software. That is, the script clearing system 140 can perform the above-described methods on a script in real-time or near real-time, as a writer writes a script in the script writing software. In some embodiments, the script clearance system 140 can iteratively perform clearance searches using the above-described methods throughout the writing process in the script writing software.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred herein as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

1) A method for automatically analyzing a script for legal clearance while retaining a contextual analysis of the script, the method comprises:
automatically identifying one or more script elements within the script based on one or more of a script property and a script content;
generating one or more script segments from the one or more script elements, each script segment being generated to be reflective of script-specific features to enable the contextual analysis of the script;
evaluating the one or more script segments to automatically generate an entity identification prompt comprising plain language text for triggering identification of one or more entities within the one or more script segments, the entity identification prompt being generated to reflect a script structure to offer the contextual analysis of the script;
for each script segment, evaluating the script segment with one or more entity identification data models configured to receive the entity identification prompt to automatically identify the one or more entities within the script segment;
generating a set of entities from the one or more entities identified from the one or more script segments;
defining a characteristics prompt for each entity of the set of entities, the characteristics prompt comprising a set of prompts for extracting from the script a set of entity characteristics related to an entity type and the entity;
for each entity of the set of entities, evaluating the script with one or more entity characteristics data models configured to receive the associated characteristics prompt to automatically extract the set of entity characteristics from the script;
displaying an interactive script embedded with at least a subset of each set of entity characteristics;
receiving, via a user interface, a user feedback in respect of one or more of the set of entities and the script; and
in response to an approval from a user via the user interface, identifying a set of clearance searches to be performed for each entity according to the entity type.

2) The method of claim 1) further comprises:
operating the one or more entity characteristics data models to generate an entity description with the set of entity characteristics extracted for each entity to provide context for the entity in order to facilitate the user feedback.

3) The method of claim 1) further comprises:
analyzing the set of entities to remove any repeated references.

4) The method of claim 3), wherein analyzing the set of entities to remove any repeated references comprises:
analyzing the script to determine one or more entities identified following the entity identification prompt is the same entity.

5) The method of claim 4), wherein the one or more entities comprises one or more different identifiers within the script.

6) The method of claim 1), wherein:
receiving the user feedback in respect of the one or more of the set of entities and the script comprises:
receiving a modification of at least one entity of the set of entities based on a review of the interactive script; and
the method further comprises:
analyzing the user feedback to identify one or more issues related to the script analysis; and
modifying one or more of the entity identification prompt and the characteristics prompt to address the one or more issues.

7) The method of claim 6), wherein analyzing the user feedback to identify the one or more issues related to the script analysis comprises:
analyzing the user feedback received from a plurality of interactive scripts.

8) The method of claim 1), wherein the entity type is selected from one or more of a character, a business, a set type, a media reference, and a location.

9) The method of claim 1), wherein defining the characteristics prompt for each entity of the set of entities comprises:
analyzing the entity to identify the associated entity type;
determining one or more characteristics critical for that entity and the entity type; and
defining the set of prompts for collecting the set of entity characteristics related to the one or more characteristics.

10) The method of claim 1), wherein the one or more entity identification data models and the one or more entity characteristics data models comprise one or more generative data models.

11) A system for automatically analyzing a script for legal clearance while retaining a contextual analysis of the script, the system comprising:
a processor operable to:
automatically identify one or more script elements within the script based on one or more of a script property and a script content;
generate one or more script segments from the one or more script elements each script segment being generated to be reflective of script-specific features to enable the contextual analysis of the script;
evaluating the one or more script segments to automatically generate an entity identification prompt comprising plain language text for triggering identification of one or more entities within the one or more script segments, the entity identification prompt being generated to reflect a script structure to offer the contextual analysis of the script;
for each script segment, evaluating the script segment with one or more entity identification data models configured to receive the entity identification prompt to automatically identify the one or more entities within the script segment;
generate a set of entities from the one or more entities identified from the one or more script segments;
define a characteristics prompt for each entity of the set of entities, the characteristics prompt comprising a set of prompts for extracting from the script a set of entity characteristics related to an entity type and the entity;
for each entity of the set of entities, evaluate the script with one or more entity characteristics data models configured to receive the associated characteristics prompt to automatically extract the set of entity characteristics from the script;
display an interactive script embedded with at least a subset of each set of entity characteristics;
receive, via a user interface, a user feedback in respect of one or more of the set of entities and the script; and
in response to an approval from a user via the user interface, identify a set of clearance searches to be performed for each entity according to the entity type.

12) The system of claim 11), wherein the processor is operable to:
operate the one or more entity characteristics data models to generate an entity description with the set of entity characteristics extracted for each entity to provide context for the entity in order to facilitate the user feedback.

13) The system of claim 11), wherein the processor is operable to:
analyze the set of entities to remove any repeated references.

14) The system of claim 13), wherein analyzing the set of entities to remove any repeated references comprises:
analyzing the script to determine one or more entities identified following the entity identification prompt is the same entity.

15) The system of claim 14), wherein the one or more entities comprises one or more different identifiers within the script.

16) The system of claim 11), wherein:
receiving the user feedback in respect of the one or more of the set of entities and the script comprises:
receiving a modification of at least one entity of the set of entities based on a review of the interactive script; and
the processor is operable to:
analyze the user feedback to identify one or more issues related to the script analysis; and
modify one or more of the entity identification prompt and the characteristics prompt to address the one or more issues.

17) The system of claim 16), wherein analyzing the user feedback to identify the one or more issues related to the script analysis comprises:
analyzing the user feedback received from a plurality of interactive scripts.

18) The system of claim 11), wherein the entity type is selected from one or more of a character, a business, a set type, a media reference, and a location.

19) The system of claim 11), wherein defining the characteristics prompt for each entity of the set of entities comprises:
analyzing the entity to identify the associated entity type;
determining one or more characteristics critical for that entity and the entity type; and
defining the set of prompts for collecting the set of entity characteristics related to the one or more characteristics.

20) The system of claim 11), wherein the one or more entity identification data models and the one or more entity characteristics data models comprise one or more generative data models.
